(19) United States
(12) Patent Application Publication
(10) Pub. No.: US 2004/0190389 A1
(43) Pub. Date: Sep. 30, 2004

(54) Recording medium, recording apparatus and reproducing apparatus

(76) Inventors: Toshihisa Nakano, Neyagawa-shi (JP); Yuichi Futa, Osaka-shi (JP); Motoji Ohmori, Hirakata-shi (JP); Shunji Harada, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/805,387

(22) Filed: Mar. 22, 2004

(30) Foreign Application Priority Data
Mar. 24, 2003 (JP) 2003-081466

(51) Int. Cl. G11B 7/085

(52) U.S. Cl. 369/30.03

(57) ABSTRACT

A DVD-RMA4 on which contents, digital copyrighted works, wherein one or more first contents and a first list information (music list) showing a list of said one or more first contents (for example, CPRM and CPS2) are recorded by a first recording method, one or more second contents and a second list information (music list) showing a list of said one or more second contents are recorded by a second recording method (for example, non-CP), and a common list information (master music list) showing a list of contents including the contents indicated in the first list information and the contents indicated in the second list information are recorded.

### TECHNICAL FIELD

The present invention relates to a recording medium, a recording apparatus and a reproducing apparatus especially to the recording medium, the recording apparatus and the reproducing apparatus for recording a plurality of contents, which are digital copyrighted works, on a recording medium and reproducing the contents.

### BACKGROUND ART

In recent years, following the rapid development of multimedia related technologies and an introduction of mass storage media (for example, DVD-RAM), a situation that the recording medium, the recording apparatus and the reproducing apparatus are becoming available at affordable prices has started to be seen. Under such situation, following usage method has been generalized: a usage method for recording music data in a plurality of music CDs as whole albums onto a DVD-RAM by the recording medium, selecting music out of the plurality of recorded music data on the DVD-RAM by the reproducing apparatus and playing back the selected music data (for example, refer to Japanese Laid Open Patent application No. 2003-059238 (Page 1-11, FIG. 1)).

Since the DVD-RAM has enormous mass storage space, a large volume of music data in the plurality of albums can be stored. In this case, it becomes difficult to select a piece of music if only music data are recorded on a recording medium.

To solve such problem, for example as shown in FIG. 1, it is suggested to create a plurality of holders (in graphic examples, shown as “CPRM” and “non-CP”) and the plurality of music data and a list of the music data are recorded by a CPRM (Content Protection for Recordable Media) method in a holder CPRM, and the plurality of music data and a list of contents of the music data are recorded by a non-CP (non-Content Protection) method in a holder non-CP. A CPRM is one of copy right protection technique for preventing unauthorized content use such as unauthorized reproduction and copying to protect copyrights of contents. As mentioned above, by recording music data and a music list as a pair for each method, the list of all music in the music data recorded on a DVD-RAM is read out when the DVD-RAM is inserted into a recording apparatus. Thus, it becomes possible to display the list of all music so that selecting music becomes much easier.

However, the above-described method is inefficient and time consuming process because it needs to generate a music list of all music after reading out a music list of CPRM contents and a music list of non-CP contents separately.

Therefore, the present invention aims to solve the above-mentioned technical problems and provide a recording medium, a recording apparatus, a reproducing apparatus, and the like which can display a list of all music efficiently.

### DISCLOSURE OF INVENTION

To achieve the above mentioned objective, the recording medium according to the present invention is a recording medium on which contents are recorded, the contents being digital copyrighted works, wherein on the recording medium, one or more first contents and first list information indicating a list of said one or more contents are recorded by a first recording method; one or more second contents and second list information indicating a list of said one or more second contents are recorded by a second recording method; and common list information indicating a list of contents including the contents indicated in the first list information and the contents indicated in the second list information are recorded.

Therefore, a user does not need to read both the first list information and the second list information, but only read the common list information directory. As the result, it becomes possible to display the all music list efficiently.

Specifically, the recording medium according to the present invention, wherein the first recording method records contents after encrypting the contents to protect copyrights of the contents, and the second recording method records contents without encrypting the contents.

Moreover, the recording medium according to the present invention, wherein the first recording method and the second recording method record contents after encrypting the contents to protect copyrights of the contents, and the first recording method and the second recording method differ in methods for the encryption.

The first recording method records ,onto the recording medium, the encrypted contents associated with secret information stored in a non-rewritable area of the recording medium, and the second recording method records, onto the recording medium, the encrypted contents associated with secret information stored in a non-rewritable area of the recording medium, and types of the secret information are different for the first recording method and the second recording method, the secret information being stored in the non-rewritable area of the recording medium.

Further, by the first recording method, key revocation data and identification information are stored in the non-rewritable area of the recording medium as the secret information, the key revocation data being used to revoke a secret key held by an apparatus which reproduces the recording medium and the identification information being used to identify the recording medium, and by the second recording method, only the identification information for identifying the recording medium is stored in the non-rewritable area of the recording medium as the secret information.

The common list information further includes information for specifying the recording methods for the contents.

The recording medium according to the present invention wherein the first list information and the second list information further include other information relating to said one or more contents respectively, and the common list information includes all the information included respectively in the first list information and the second list information.

Further, at least one of the first recording method and the second recording method uses key revocation data for revoking a secret key held by an apparatus which reproduces the recording medium, and the common list information includes information for specifying the key revocation data.

In addition, at least one of the first recording method and the second recording method further uses a revocation list which is a list of information indicating a public key certificate to be revoked held by an apparatus which reproduces the recording medium, and the common list information further includes information for specifying a website on the Internet on which the revocation list is stored.

The recording medium is a rewritable DVD.

Also, the contents are music data, wherein the first list information, the second list information and the common list information are music lists.

Note that the present invention can be realized not only as a recording medium as described above, but also as a recording apparatus comprised of units operable to edit characteristic data recorded on the recording medium, a reproducing apparatus comprised of units operable to reproduce and display the characteristic data on the recording medium, a content recording reproduction system using the recording apparatus and the reproducing apparatus and a recording method and a reproduction method that have, as their steps, the characteristic steps included in the recording apparatus and the reproducing apparatus, as well as realized as a program that causes a computer to execute such steps. And it should be noted that such program can be distributed via recording media such as CD-ROM and the transmission media such as the Internet.

As it is clear from the above explanation, the recording medium according to the present invention on which one or more first contents and a first list information showing a list of said one or more first contents are recorded by a first recording method, one or more second contents and a second list information showing a list of said one or more second contents are recorded by a second recording method, and a common list information showing a list of contents including the contents indicated in the first list information and the contents indicated in the second list information are recorded. Therefore, a user does not need to read both the first list information and the second list information, but only read the common list information directory. As the result, it becomes possible to display the all music list efficiently.

Accordingly, the present invention can decrypt a targeted content in a short time by referring to the common list information without reading management files (music list) for each recording method, that is, by having a master management file which merges the management files (music list and the like) for each recording method. Therefore, a user can access to wished data and play back the data very efficiently. Thus, the practical values of this invention is quite high today when mass storage recording medium, recording apparatus and the reproducing apparatus are becoming widely available.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a recording structure in a recording medium for a background art relating to the present invention.

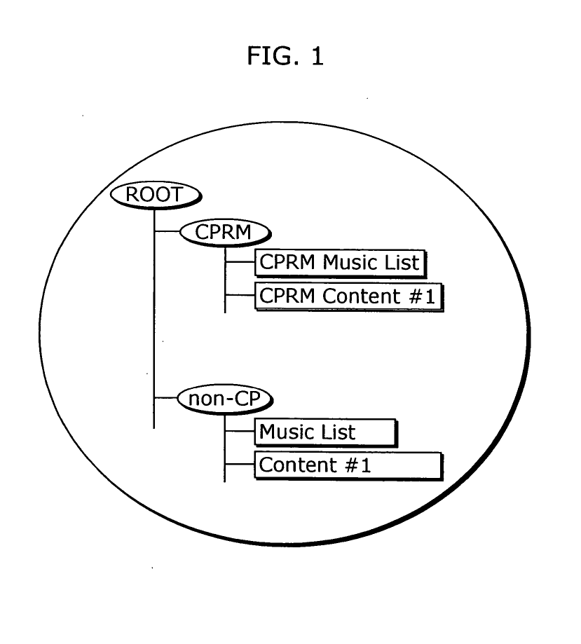

FIG. 2 is a functional block diagram showing an overall structure of a content recording reproduction system according to the embodiment of the present invention.

FIG. 3 is a diagram showing an example of a structure of a CPRM music list 1210.

FIG. 4 is a diagram showing an example of a structure of a CPS2 music list 1220.

FIG. 5 is a diagram showing an example of a structure of a non-CP music list 1230.

FIG. 6 is a diagram showing an example of a structure of a master music list 130.

FIG. 7 is a flowchart showing a process executed by an editing unit 12 and a master music list generation unit 13 in a recording apparatus 10.

FIG. 8 is a flowchart showing a process executed by a reproduction processing unit 24 in a recording apparatus 20.

FIG. 9 is a diagram showing a structure of an appearance of the reproducing apparatus 20.

FIG. 10 is a diagram showing an overall structure of a content recording reproduction system 1 by the CPS2.

FIG. 11 is a flowchart showing a sub-routine of a write-in process (S15) of music data shown in FIG. 7.

FIG. 12 is a flowchart showing a specific example of each type of data to be recorded onto each storing unit in a DVD-RAM4.

FIG. 13 is a flowchart showing a sub-routine of a reproduction process (S26) of music data shown in FIG. 8.

FIG. 14 is a flowchart showing a reproduction process (S26) of music data shown in FIG. 8.

FIG. 15 is a diagram showing an example of a structure of a CP generation ability table 2410.

FIG. 16 is a flowchart showing a part of other processes executed by the reproduction processing unit 24 of the reproducing apparatus 20.

FIG. 17 is a diagram showing other structures of the appearance of the reproducing apparatus 20.

FIG. 18 is a conceptual diagram showing other overall structures of the CPS2 recording method used for the content recording reproduction system 1a.

### BEST MODE FOR CARRYING OUT THE INVENTION

Following explains in detail about an embodiment of the present invention with reference to diagrams.

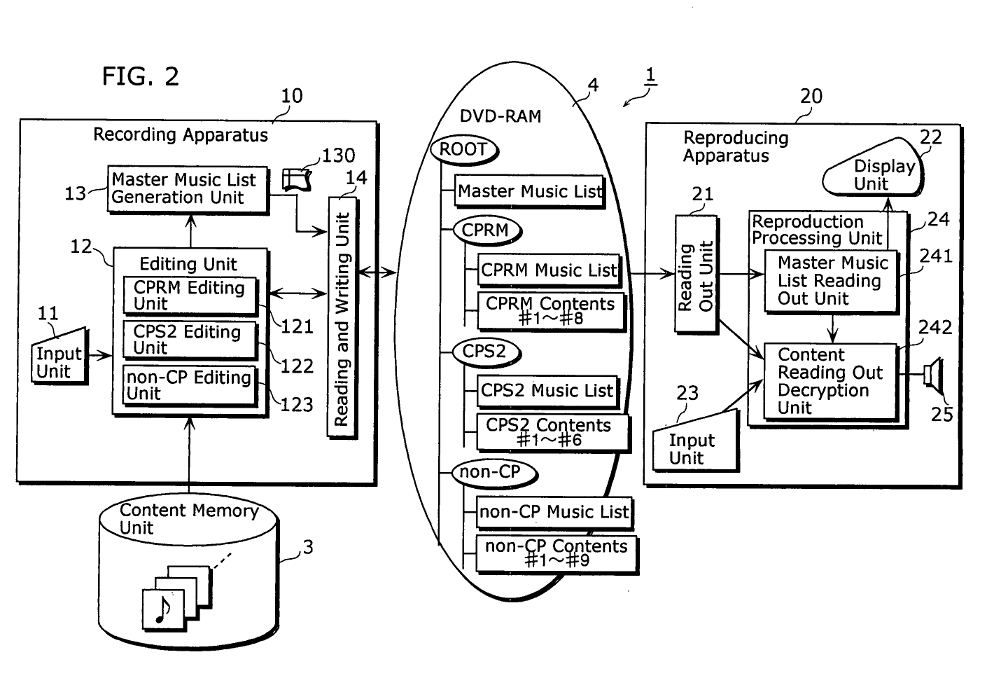

FIG. 2 is a functional block diagram showing an overall structure of a content recording reproduction system according to the present invention.

As shown in FIG. 2, a content recording reproduction system 1 comprises a content memory unit 3 which previously memorizes a plurality of music data in each album that are contents as digital copyrighted works, a DVD-RAM4 as a recording medium, a recording apparatus 10 which records a plurality of music data, a music list and the like on the DVD-RAM4, a reproducing apparatus 20 which reproduces the plurality of music data recorded on the DVD-RAM4 and the like.

The content memory unit 3, for example, a memory unit of an AV server set up at home, memorizes a plurality of contents (music data in each album). As a matter of convenience for an explanation, it is assumed that the music data memorized in the content memory unit 3 are not encrypted.

The DVD-RAM 4 has a non-rewritable area (read-in area) and a rewritable area. In the read-in area, key block revocation data which can revoke a key held by the reproducing apparatus 20 and a unique Media ID for the DVD-RAM4 are previously recorded. In the rewritable area, a plurality of contents and the like can be recorded by predetermined methods (CPRM, CPS2 (Content Protection System 2), non-CP and the like).

In here, the CPRM and the CPS2 are copy control technique. The CPRM associates key revocation data and a media ID with a content, and the CPS2 associates a media ID recorded in the read-in area with a content. Thus, both methods are a technique of a media bind method for recording contents after encrypting them which prevents content reproductions on unauthorized apparatuses for protecting copyrights. On the other hand, the non-CP is a standard technique without the copyrights protection which records contents without encrypting them. The CPS2 is discussed later in detail.

The DVD-RAM4 is not limited to its standard type but can be a Blu-ray Disc which is a next generation DVD. Also, as a matter of convenience for an explanation, it is assumed that the rewritable area is left blank in which no music data and the like are written before the DVD-RAM4 is used. While the recording medium may be an optical disk such as DVD-RW, hard disk and memory cards such as SD card, MD card, smart media, memory stick and the like, the DVD-RAM4 is used to explain as a representative of recording media.

The recording apparatus 10 includes an input unit 11, an editing unit 12, a master music list generation unit 13, and a reading and writing unit 14.

The input unit 11 is made up with manual operation buttons, a mouse and the like. It obtains contents that should be recorded on the DVD-RAM4, instructions by a user about the music data and the like by album as a unit.

The editing unit 12 reads out the plurality of contents (for example, music data in each album) by track from the content memory unit 3, edits the contents and a music list of the contents by a predetermined method, based on an instruction by a user which the input unit 11 obtained, including a CPRM editing unit 121 which edits contents by the CPS2 method, a CPS 2 editing unit 122 which edits contents by the CPS2 method, and a non-CP editing unit 123 which edits contents without content protection (CP). A music list for each music data is formed of an “album title”, “music titles”, and “length of a track”. A user can obtain an “album title” and “music titles” in the music list via the Internet, or create the titles by themselves. In addition, the contents can be managed not only by each album but also by each piece of music. Further, in the case where music is added for recording onto a recording medium in which all music have been recorded and the master music list has been existed already, the master music list can be updated.

The CPRM editing unit 121 encrypts music data in each album which should be recorded onto a DVD-RAM4 according to key revocation data and a Media ID read-out from the DVD-RAM4 via the reading and writing unit 14. Then, the CPRM editing unit 121 writes an edited music list (CPRM music list), the encrypted music data and the like into one of DVD-RAM4 directories via the reading and writing unit 14 (For example, the CPRM).

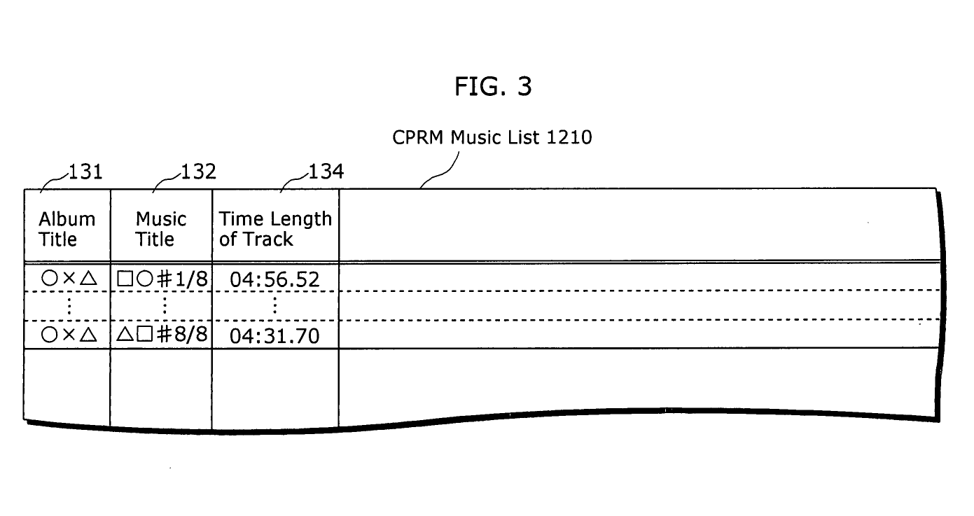

FIG. 3 is a diagram showing an example of a structure of the CPRM music list edited by the CPRM editing unit 121.

As shown in FIG. 3, the CPRM music list 1210 is formed of fields such as an “album title” 131 assigned to a plurality of music data, a “music title” 132 for music data and a “time length of a track” 134 which indicates time of music data, and records for each music data.

The CPS2 editing unit 122 encrypts music data in each album which should be recorded onto a DVD-RAM4 according to a Media ID read-out from the DVD-RAM4 and the like via the reading and writing unit 14. Then, the CPS2 editing unit 122 writes the edited music list (CPS2 music list), the encrypted music data and the like into one of the DVD-RAM4 directories via the reading and writing unit 14 (For example, the CPS2).

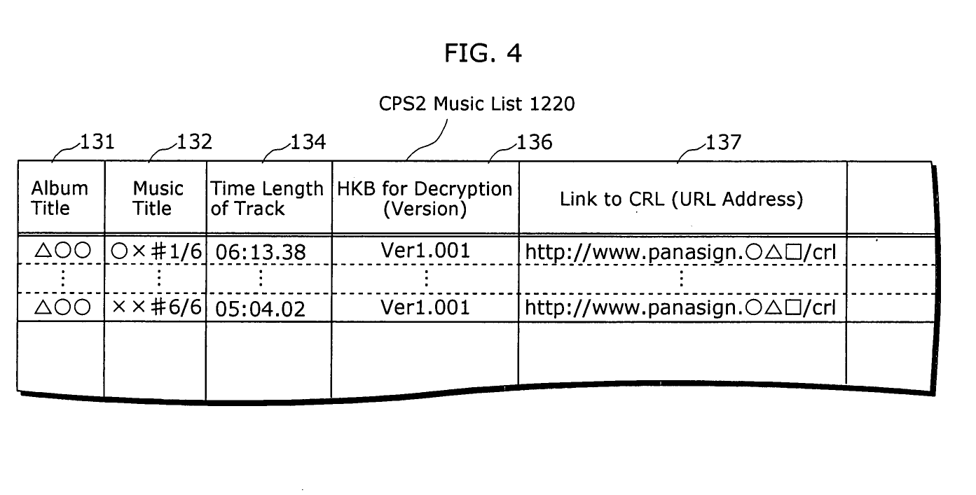

FIG. 4 is a diagram showing an example of a structure of the CPS2 music list edited by the CPS2 editing unit 122.

As shown in FIG. 4, the CPS2 music list 1220 is formed of fields and records. In addition to the album title 131, the music title 132 and the time length of a track 134, the fields include such as a “HKB for a decryption” 136 which indicates information for specifying key block revocation data HKB to be used in the case where the CP method is the CPS2, and “a link to CRL” 137 which indicates a URL address in which a certificate revocation list CRL used in the case where the CP method is the CPS2, and the records for each music data are stored.

The non-CP editing unit 123 writes an edited music list (non-CP music list) and music data which are not encrypted into one of the DVD-RAM4 directories (For example, the non-CP).

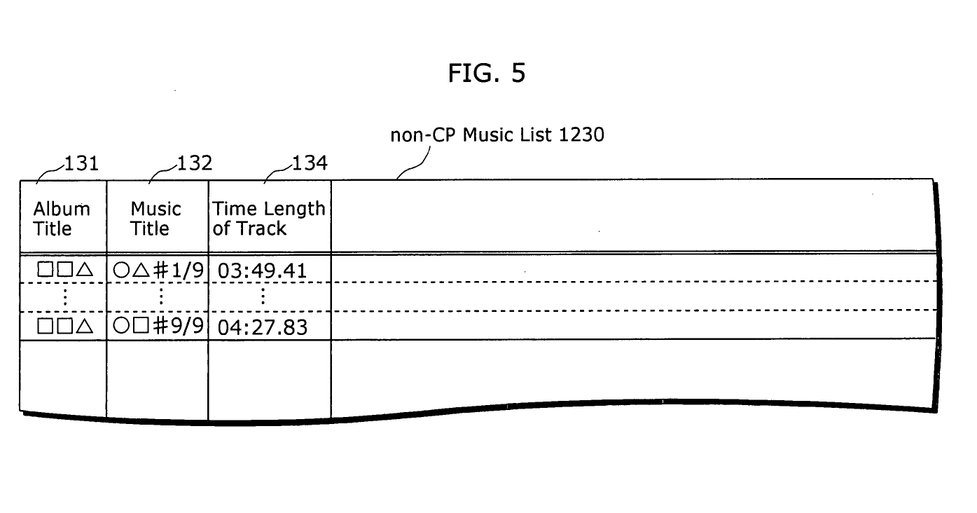

FIG. 5 is a diagram showing an example of a structure of the non-CP music list edited by the non-CP editing unit 123.

As shown in FIG. 5, the non-CP music list 1230 is formed of fields such as the album title 131, the music title 132 and the time length of a track 134, and records for each music data.

The master music list generation unit 13 generates a master music list 130 by collecting all of music lists from the plurality of albums edited by the editing unit 12, the CP method executed by the CPRM editing unit 121˜non-CP editing unit 123, and the like. Then, the master music list generation unit 13 writes the generated master music list 130 into a root directory of the DVD-RAM4 via the reading and writing unit 14.

The above-mentioned editing unit 12 and the master music list generation unit 13 are realized by a CPU, ROM in which stores a program executed by the CPU, memory which provides a work area when the program is executed and in which many inputted data and the like are temporary stored, and the like.

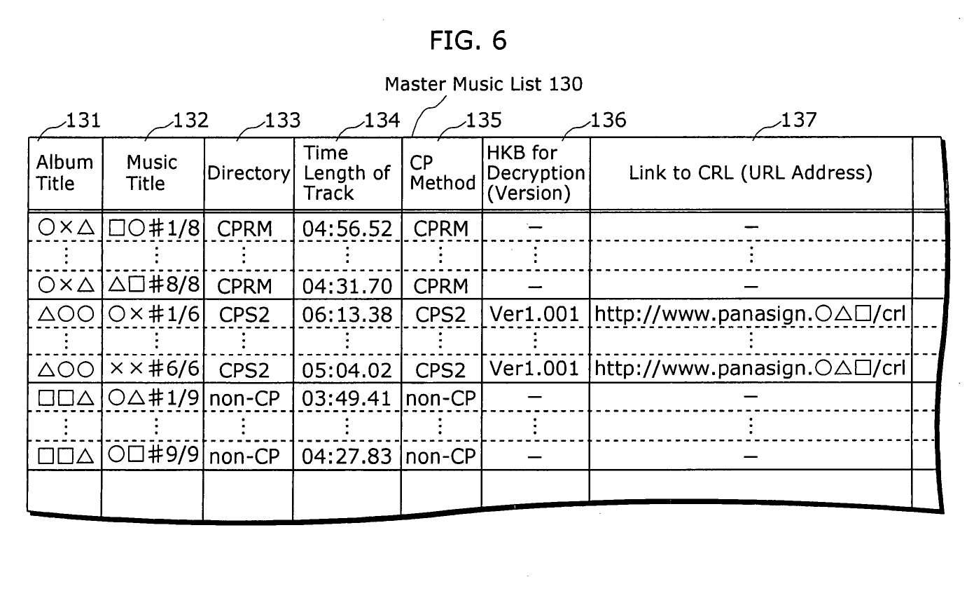

FIG. 6 is a diagram showing an example of a structure of the above-mentioned master music list 130.

As shown in FIG. 6, the master music list 130 is formed of fields and records for each music data. In addition to the album title 131, the music title 132, the time length of a track 134, HKB 136 for a decryption, and the link to CRL 137, the fields further include a “directory” 133 in which music data and music lists are stored, and a “CP method” 135 which indicates a protection method for music data.

That is, the master music list 130 is formed by merging the CPRM music list 1210, the CPS2 music list 1220 and the non-CP music list 1230, and by further adding the directory 133 and the CP method 135.

By recording the master music list 130 which has the structure as above described into the DVD-RAM4, it becomes possible for the CPRM editing unit 121˜non-CP editing unit 123 to quickly select contents recorded on the DVD-RAM4 only by reading a master music list without referring to recorded music lists by each method.

In addition to “a type of content”, “a starting point” of each track, “a size” of track data and the like, fields such as “artists”, “composers” and “a genre” may be added to the master music list 130.

The reading and writing unit 14 is formed of an optical pickup and the like. The reading and writing unit 14 unit (1) irradiates the DVD-RAM4 inserted into a drive with laser beam, (2) accesses to a read-in area in the DVD-RAM4 according to an instruction from the editing unit 12, and (3) reads out key block data and a media ID or writes different types of contents, music lists and the like edited by the editing unit 12 and the master music list generated by the master music list generating unit 13 into a read-in area in the DVD-RAM4.

The reproducing apparatus 20 includes a reading out unit 21, a display unit 22, an input unit 23, a reproduction processing unit 24, and a speaker 25.

The reading out unit 21 which is formed of an optical pickup and the like irradiates the DVD-RAM4 inserted into the drive with laser beam and reads out the master music list written in the DVD-RAM4 according to an instruction from the reproduction processing unit 24 and contents data for various methods.

The display unit 22 which is formed of a Liquid Crystal Display (LCD) and the like displays a list of contents shown as common list information (a master music list) read-out by a reproduction processing unit 24.

The input unit 23 which is formed of manual operation buttons, a mouse and the like obtains a selection instruction and the like by a user to the list of contents displayed on the display unit 22.

The reproduction processing unit 24 is a processing unit which centrally controls the reading out unit 21, the display unit 22, the input unit 23, the speaker 25 for a smooth reproduction process for contents, the processing unit is formed of a master music list reading out unit 241 and a content reading out decryption unit 242. The master music list reading out unit 241 gives an instruction to the reading out unit 21 and reads out the common list information recorded on the DVD-RAM4 via the reading out unit 21. The content reading out decryption unit 242 reads out a content corresponding to a selection instruction via the reading out unit 21 based on the selection request by a user to a list of obtained content by the input unit 23 and reproduces the content with the speaker 25.

The master music list reading out unit 241 and the content reading out decryption unit 242 comprising the reproduction processing unit 24 are realized by CPU, ROM which stores a program executed by CPU, memory which provides a work area when the program is executed and temporally stores various inputted data and the like.

Next, operations in the recording apparatus 10 are explained.

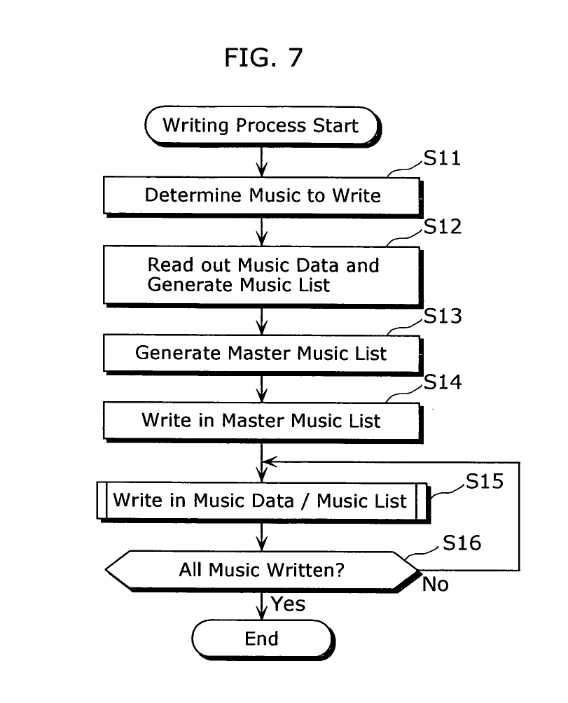

FIG. 7 is a flowchart indicating a process executed by the editing unit 12 and the master music list generation unit 13 in the recording apparatus 10.

The editing unit 12 determines music to be read into the DVD-RAM4 based on an instruction by a user inputted from the input unit 11 (S11). Then, the editing unit 12 reads out the determined contents (for example, music data as an entire album) by each track, edits the read-out contents, and generates the music list of the contents (S12).

After editing the music data and the music list, the master music list generation unit 13 generates a master music list by collecting music list of each album (S13). Then, the master music list generation unit 13 writes the master music list in the DVD-RAM4 via the reading and writing unit 14 (S14).

After finished writing the master music list, the editing unit 12 writes music data and a music list one by one (S15, S16). The editing unit 12 also encrypts the music data if necessary.

As shown in FIG. 2, onto the DVD-RAM4, a plurality of music data and a music list of the music data are recorded by the CPRM method, the plurality of music data and the music list of the music data are recorded by the CPS2 method, the plurality of music data and the music list of the music data are recorded by the non-CP method, and the master music list which indicates a list of contents is recorded. The list of contents includes the music data recorded by the CPRM, the music data recorded by the CPS2, and the music data recorded by the non-CP.

Next, operations in the reproducing apparatus 20 are explained.

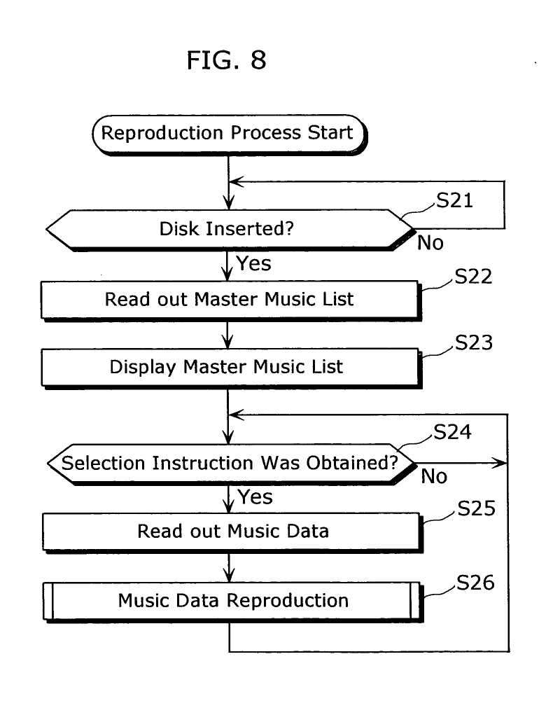

FIG. 8 is a flowchart showing a process executed by a reproduction processing unit 24 in the reproducing apparatus 20.

The master music list reading out unit 241 waits for a disc to be inserted into a drive (S21). Once the disk is inserted (S21 Yes), the master music list reading out unit 241 reads out the master music list written in the DVD-RAM4 via the reading out unit 21 (S22). Then, the master music list reading out unit 241 displays the read-out master music list on the display unit 22 as shown in FIG. 6 (S23). Here, whether or not the disk is inserted is judged. For example, it is judged by examining whether the reading out unit 21 receives lights irradiated to the disk.

According to the above mentioned recording reproduction process, the master music list can be read-out in a short period of time from the DVD-RAM4 without reading management lists (music lists) for each CP recording method. Therefore, a user can select desired music data immediately by displaying all music lists efficiently.

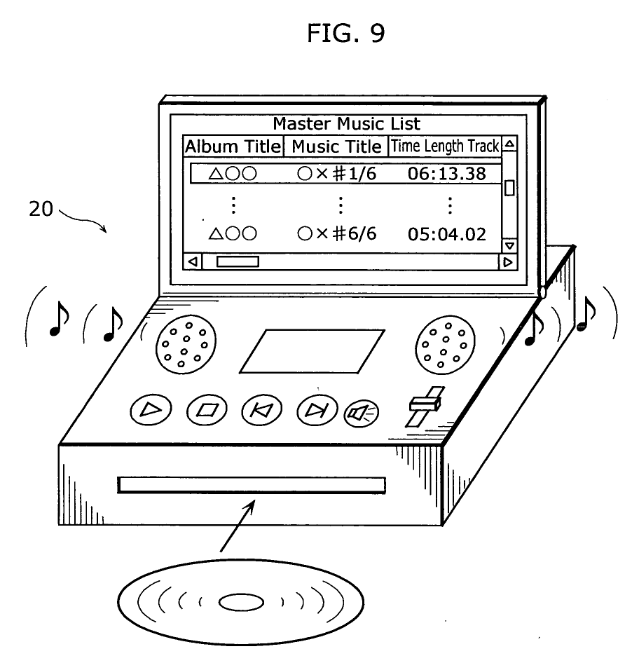

Next, the content reading out decryption unit 242 waits for the input unit 23 to obtain a selection instruction (S24). When a user plays back “music∘×#⅙” from an album “Δ∘∘”, the user, as shown in FIG. 9, can put a cursor on the music and push a playback button. Once the input unit 23 obtains the selection instruction (S24 Yes), the content reading out decryption unit 242 specifies a storage location, a recording method for contents corresponding to the selection instruction with reference to the master music list, and reads out the contents corresponding to the selection instruction (music data, for example the music title “∘×#⅙” shown in FIG. 6) from the DVD-RAM4 (S25). Then, the content reading out decryption unit 242 performs a process corresponding to the recording method specified for the read-out music data (for example, a decryption process by the CPS2 for the music title “∘×#⅙”), and plays back the music data with the speaker 25 (S26).

According to the above mentioned recording reproduction process, it becomes possible to easily specify a HKB to be reffered, readily obtain a CRL from a website, and decrypt the desired music data in a short period of time without reading the management files (music lists) for each recording method, with reference to the master music list from the DVD-RAM4, that is, by having only master list which merged management files for each CP recording method.

Next, according to the CP method as the CPS2 as an example, a functional structure of the recording apparatus 10, contents recorded onto the DVD-RAM4, the related data and a functional structure of the reproducing apparatus 20 are described in detail.

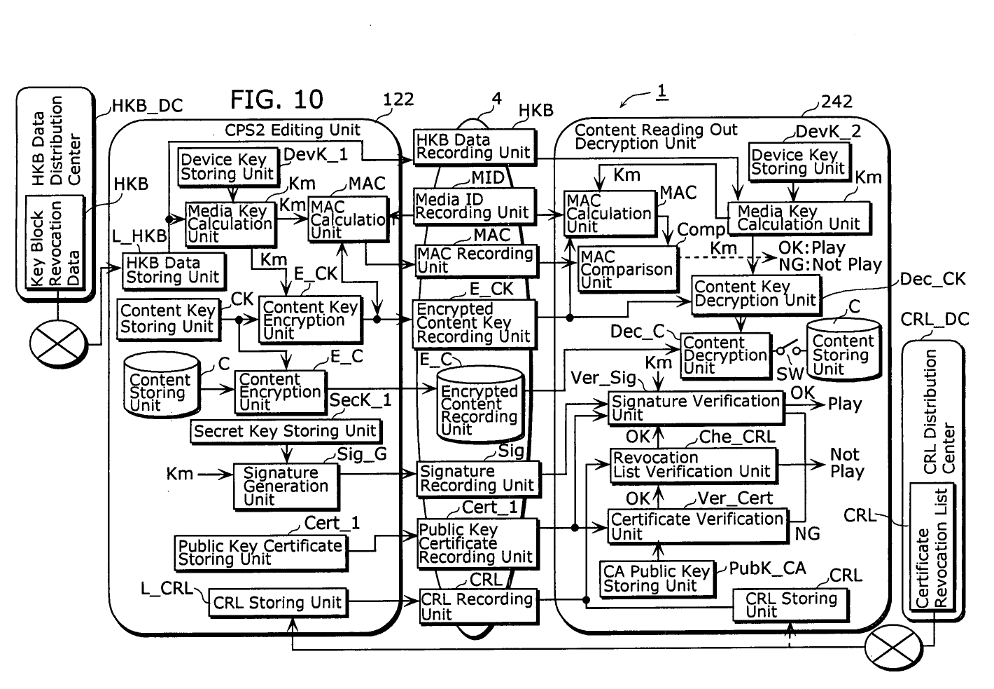

FIG. 10 is a diagram showing an overall structure of the content recording reproduction system 1 by the CPS2. In the diagram, it is indicated that a functional structure of the CPS2 editing unit 122 as a recording apparatus 10, a functional structure of the content reading out decryption unit 242 as a reproducing apparatus 20, and a recording structure by the CPS2 as a DVD-RAM4.

The CPS2 editing unit 122 in a recording apparatus 10 includes a device key storing unit DevK_1, a key block data storing unit L_HKB, a media key calculation unit Km, a massage authentication code calculation unit MAC, a content key storing unit CK, a content key encryption unit E_CK, a content storing unit C, a content encryption unit E_C, a secret key storing unit SecK_1, a public key certificate storing unit Cert_1, a certificate revocation list storing unit L_CRL, a signature generation unit Sig_G and the like.

The device key storing unit DevK_1 previously stores a unique device key secretly held in each apparatus.

The key block data storing unit L_HKB accesses a key block data distribution center via the Internet, obtains the latest key block data which are a collection of encryption media keys (including the revoked ones) encrypted with the device keys, and stores the data. Then, the key block data storing unit L_HKB records the key block data onto the key block data recording unit HKB in a DVD-RAM4.

The media key calculation unit Km calculates a media key from decrypting the key block data with the device key.

The content key storing unit CK obtains a content key for encrypting a content to be recorded onto the DVD-RAM4 from outside (for example, a content memory unit 3) and stores the content key.

The content key encryption unit E_CK encrypts the content key stored in the content key storing unit CK with a media key calculated by the media key calculation unit Km. Then, the content key encrypting unit E_CK records the encrypted content key onto the encrypted content key recording unit E_CK in the DVD-RAM4.

The message authentication code calculation unit MAC calculates a message authentication code (MAC) from a media key calculated by the media key calculation unit Km, a content key encrypted by the content key encryption unit E_CK and a media ID read-out from the media ID recording unit MID. Then, the MAC calculation unit records the calculated MAC onto the MAC recording unit MAC in the DVD-RAM4.

The content storing unit C stores contents obtained from outside (for example, the content memory unit 3).

The content encryption unit E_C encrypts the inputted content from the outside with the content key. Then, the content encryption unit E_C records the encrypted content onto the encrypted content recording unit E_C.

The public key certificate storing unit Cert_1 previously obtains a public key certificate given a signature by a central authority (hereafter also referred to as CA) to the public key in a public key cryptosystem.

The certificate revocation list storing unit L_CRL accesses a key block data distribution center via the Internet, previously obtains the latest public key certificate revocation list (hereafter also referred to as CRL) which shows a list of revoked public key certificates, and stores the CRL.

The secret key storing unit SecK_1 previously stores a secret key corresponding to a public key in the public key cryptosystem.

The signature generation unit Sig_G generates a signature to the media key with the secret key.

Corresponding to the above described CPS2 editing unit 122, the DVD-RAM4 includes a media ID recording unit MID, a key block revocation data recording unit HKB, a message authentication code recording unit MAC, an encrypted content key recording unit E_CK, an encrypted content recording unit E_C, a signature recording unit Sig, a certificate revocation list recording unit CRL, and a public key certificate recording unit Cert_1.

The media ID recording unit MID in the DVD-RAM4 is located in a non-rewritable area and previously records a media ID.

The key revocation data recording unit HKB records the latest key block data which is a collection of encrypted media keys (including the revoked ones) encrypted with device keys.

The message authentication code recording unit MAC records a message authentication code calculated from a media key, an encrypted content key and a media ID.

The encrypted content key recording unit E_CK records the encrypted content key.

The encrypted content recording unit E_C records the encrypted content.

The signature recording unit Sig records the signature generated by the signature generation unit Sig_G.

The certificate revocation list recording unit CRL records the CRL held in the certificate revocation list storing unit L_CRL.

The public key certificate recording unit Cert_1 records a certificate.

Next, a structure of the content reading out decryption unit 242 in a content reproducing apparatus 20 is explained.

The content reading out decryption unit 242 includes a device key storing unit DevK_2, a media key calculation unit Km, a message authentication code calculation unit MAC, a message authentication code comparison unit Comp, a content key decryption unit Dec_CK, a content decryption unit Dec_C, a CA public key storing unit PubK_CA, a certificate verification unit Ver_Cert, a certificate revocation list storing unit CRL, a revocation list verification unit Che_CRL, a signature verification unit Ver_Sig, a switch SW and the like.

The device key storing unit DevK_2 stores a device key held secretly by each apparatus.

The media key calculation unit Km calculates a media key from decrypting media key data read-out from the DVD-RAM4 with the device key.

The message authentication code calculation unit MAC calculates a message authentication code from the calculated media key and the media ID read-out from the DVD-RAM4.

The message authentication code comparison unit Comp compares a message authentication code calculated by the message authentication calculation unit MAC with a message authentication code read-out from the DVD-RAM4.

The content key decryption unit Dec_CK decrypts an encrypted content key read-out from the DVD-RAM4 with the calculated media key.

The content decryption unit Dec_C decrypts an encrypted content read-out from the DVD-RAM4 with the decrypted content key.

The CA public key storing unit PubK_CA stores a public key of the CA.

The certificate verification unit Ver_Cert verifies a validity of a certificate read-out from the DVD-RAM4 with a public key of the CA, that is, verifies a signature given on the certificate.

The certificate revocation list storing unit CRL stores the latest CRL.

The certificate verification unit Ver_Cert verifies a validity of a CRL read-out from the DVD-RAM4 using the public key of the CA, that is, verifies a signature given on the CRL.

The revocation list verification unit Che_CRL compares old and new of the CRLs stored in the certificate revocation list storing unit CRL and stores the latest CRL into the certificate revocation list storing unit CRL.

Also, the revocation list verification unit Che_CRL judges whether or not a certificate read-out from the DVD-RAM4 is registered in the latest CRL stored in the certificate revocation list storing unit CRL.

The signature verification unit Ver_Sig verifies a signature read-out from the DVD-RAM4 using the certificate similarly read-out from the DVD-RAM4.

The switch SW is controlled based on various verifications and the results of the verifications.

Next, the writing process executed by each unit in the CPS2 editing unit 122 is explained.

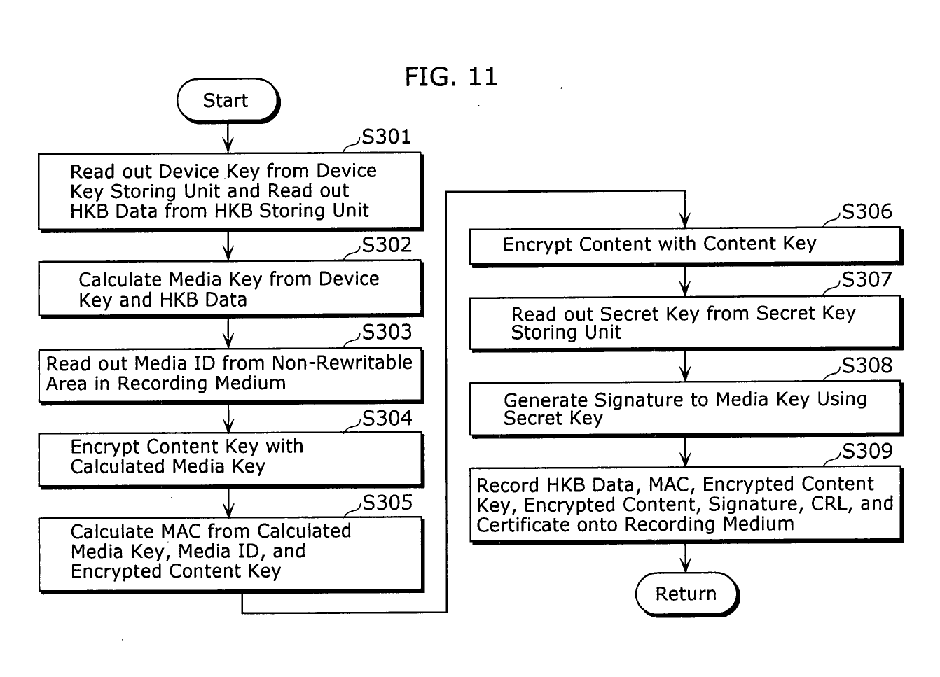

FIG. 11 is a flowchart indicating a sub-routine of the writing process (S15) for music data shown in FIG. 7.

The media key calculation unit Km reads out a device key from the device key storing unit DevK_1 and media key data from a key block data storing unit (S301). Then, the media key calculation unit Km obtains a media key by decrypting the key block revocation data with the device key using the device key and the key block revocation data read-out at step S301 (S302).

Next, the message authentication code calculation unit MAC reads out a media ID from the media ID recording unit MID which is a non-rewritable area in the DVD-RAM4 (S303).

Using the calculated media key at step S302, an externally inputted content key is encrypted (S304). Then, the message authentication code calculation unit MAC calculates a message authentication code from the media key obtained at step S302, the media ID read-out at the step S303 and the encrypted content key (S305).

Using the externally inputted content key, the content similarly inputted externally is encrypted (S306).

A secret key is read-out from the secret key storing unit SecK_1 (S307).

Using the secret key read-out at step S 307, a signature for a media key is generated (S308).

The recording apparatus 100 records the key block revocation data, the message authentication code, the CRL, the certificate used at each step and the encrypted content key, the encrypted content and the signature generated at each step onto the DVD-RAM4 (S309).

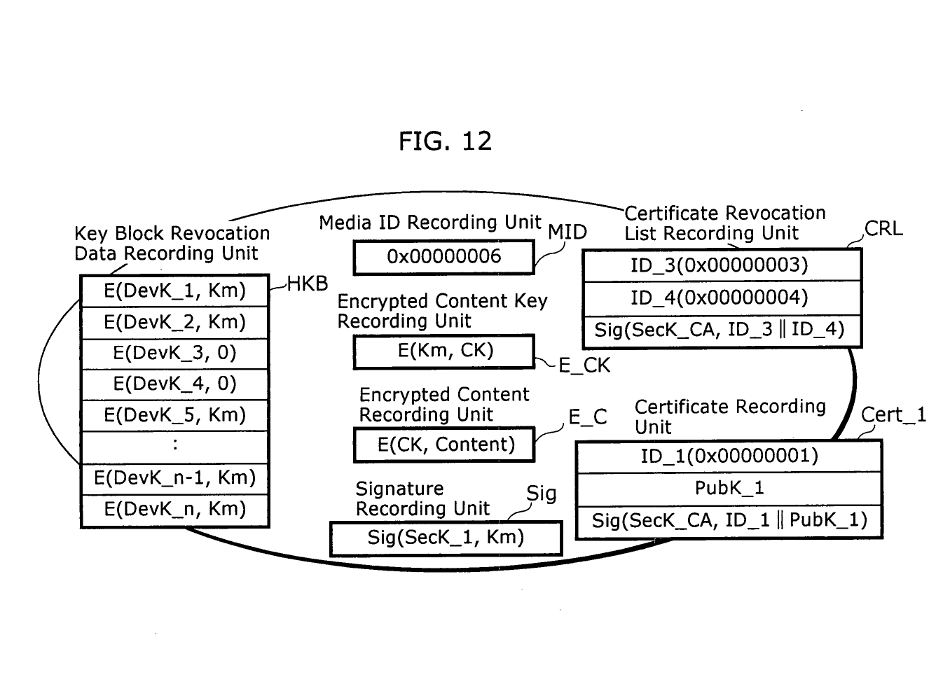

Through the process as above described, various data are stored in the media ID recording unit MID, the key block revocation data recording unit HKB, the message authentication code recording unit MAC, the encrypted content key recording unit E_CK, the signature recording unit Sig, the certificate revocation list recording unit CRL, and a public key certificate recording unit Cert_1 in the DVD-RAM4 as shown in FIG. 12.

In here, when it is assumed that a total number of apparatuses is n and that the apparatus 3 and 4 are revoked, each type of data on the DVD-RAM4 recorded by the apparatus i is explained based on specific examples. Each of n apparatuses n has single own device key.

### Media ID Recording Unit MID

The media ID recording unit MID is a non-rewritable area in which a media ID number for each DVD-RAM4 is recorded.

In FIG. 12, the Media ID is described in hexadecimal number eight digits, and its ID number is “6”.

### Key Block Revocation Data Recording Unit HKB

In the key block revocation data recording unit HKB, a media key (MK) encrypted with a plurality of device keys (DevK). Here, E (X, Y) is used to indicate an encryption sentence when data X encrypted data Y. An encryption algorithm to be used can be realized by publicly known technologies; for example, a DES encryption and the like are used. Furthermore, a device key held by an apparatus n is described as DevK_n.

In FIG. 12, while the apparatuses 3 and 4 are revoked, the data “0” which has no relationship with a media key (Km) is encrypted and recorded on DevK_3 and Devk_4 held in each device. By generating media key data in this way, all apparatuses except the apparatuses 3 and 4 can only share the media key (Km) and remove the apparatuses 3 and 4 from the system. Also, other methods can be applied for a revocation method for apparatuses; for example, a revocation method using a tree structure can be used.

### Encrypted Content Key Recording Unit E_CK

In the encrypted content key recording unit E_CK, a content key encrypted with a media key (Km) is recorded.

In the message authentication code memory unit which is not shown in the diagram, a message authentication code calculated from a media ID, an encrypted content key and a media key is recorded. Here, for example, a message authentication code (MAC) is a key calculated from a value which connects the media key to the media ID and the encrypted content key as input values, and output values by the hush function.

### Encrypted Content Recording Unit E_C

On the encrypted content recording unit E_C, a content encrypted with a content key (CK) is recorded.

### Signature Recording Unit Sig

On a signature recording unit Sig, a signature generated for a media key (Km) is recorded. Here, Sig (X, Y) is used to indicate a signature sentence generated using key data X for data Y. A signature generation algorithm to be used can be realized by publicly known technology; for example, a RSA signature and the like are used.

In FIG. 12, a signature sentence generated using a secret key (SK_1) of an apparatus 1 is recorded.

### Certificate Revocation List Recording Unit CRL

On a certificate revocation list recording unit CRL, a CRL is recorded, the CRL being targeted when the apparatus 1 generates a signature. The CRL lists IDs of certificates which should be revoked (in here, certificates for the apparatuses 3 and 4). Also, the signatures of the CA are given to the IDs. A signature of the CA is to guarantee the validity of a CRL. Further, a CRL format can be either the one in a public domain or the one identified for a system.

### Public Key Certificate Recording Unit Cert_1

In the public key certificate recording unit Cert_1, a certificate corresponding to a secret key (SecK_1) used for generating a signature by the apparatus 1 is recorded. On the certificate, a certificate ID, a public key (PubK_1) and signatures of the CA for the ID and the PubK_1 are given. A signature of the CA is to guarantee the validity of a certificate. Further, a certificate format can be either the one within the public domain or the one identified for a system.

Next, a process in which the content reading out decryption unit 242 in the reproducing apparatus 20 reproduces the data read-out from the DVD-RAM4 is explained.

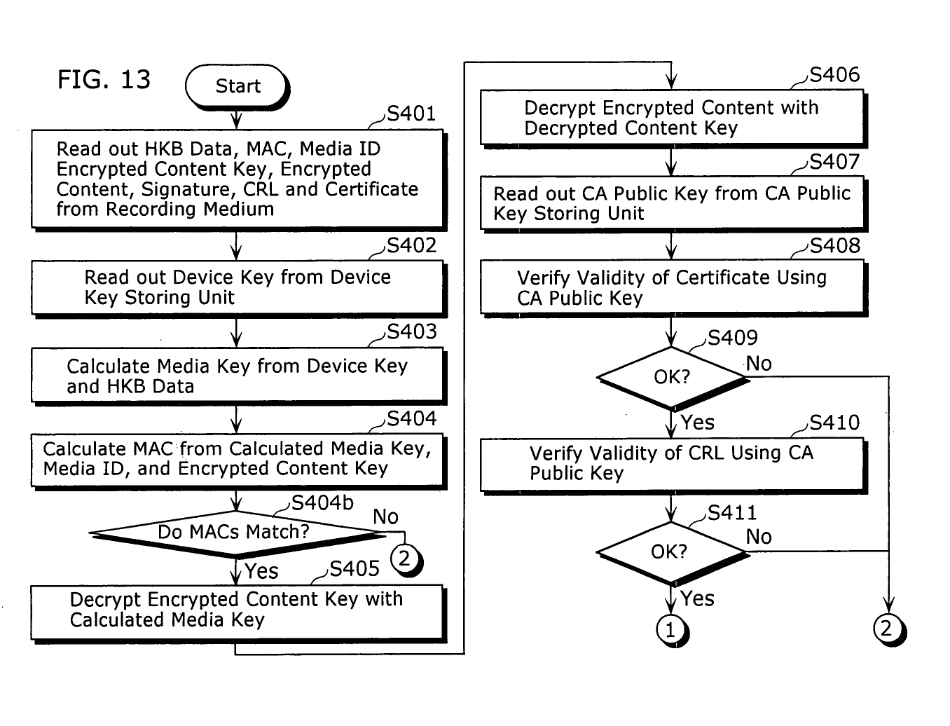

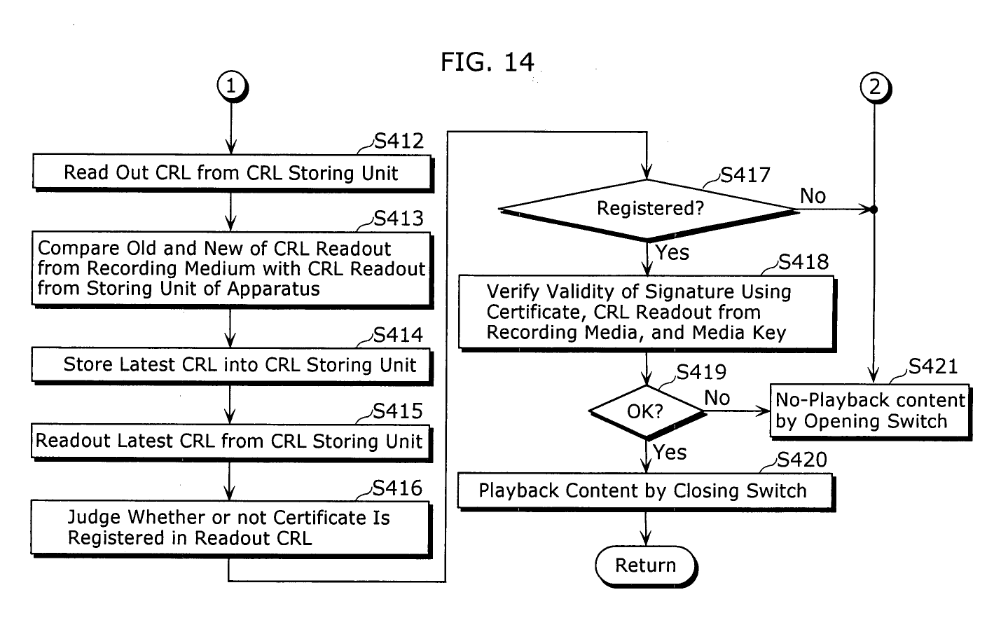

FIG. 13 and FIG. 14 are flowcharts showing a sub-routine of a reproduction process (S26) for music data shown in FIG. 8.

Each unit of the content reading out decryption unit 242 reads out respectively key block data, a message authentication code, a media ID, an encrypted content key, an encrypted content, a signature, a CRL, and a certificate from the DVD-RAM4 (S401). Then, the media key calculation unit Km reads out a device key from the device key storing unit DevK_2 (S402). Following to that, the media key calculation unit Km obtains a media key by decrypting the key block data obtained at step S403 with the device key read-out at step S402 (S403).

Next, the message authentication code calculation unit MAC calculates a message authentication code from a media ID read-out at step S401, an encrypted content key, and a media key obtained at step S403 (S404a). As a calculation method, for example, a method similar to the method shown at step S304 is used.

Then, the message authentication code comparison unit Comp judges whether or not the message code calculated by the message authentication code calculation unit MAC matches with the message authentication code obtained at step S403 (S404b). As a result of the judgement, the process move on to step S405 when the message authentication codes match at step S404b, and move on to step S421 when the message authentication codes do not math. The step S421 is discussed later.

At step S405, the content key decryption unit Dec_CK obtains the encrypted content key read-out at step S401 by decrypting it with the media key obtained at step S403. Then, the content decryption unit Dec_C obtains the content by decrypting the encrypted content read-out at step S401 with the content key obtained at step S405 (S406).

On the other hand, the certificate verification unit Ver_Cert reads out a public key of the CA from the CA public key storing unit PubK_CA (S407). Then the certificate verification unit Ver_Cert verifies a validity of the certificate read-out at step S401 using the public key of the CA read-out at step S407 (S408). The process moves on to step S421 when the verification of the validity at step S408 indicates NG (S409). The process moves on to the next step when the verification indicates OK (S410).

The revocation list verification unit Che_CRL verifies a validity of the CRL read-out at step S401 using the public key of the CA read-out at step S407 (S410). The process moves on to the step S421 when the verification of the validity at step S410 indicates NG. The process moves on to the next step when the verification indicates OK (S412).

Moreover, the revocation list verification unit Che_CRL reads out a CRL from the certificate revocation list storing unit CRL (S412). Then, the revocation list verification unit Che_CRL compares old and new of the CRL read-out at step 5401 with the CRL read-out at step S412 (S413). For example, version numbers assigned to CRLs are used for comparing old and new of the CRLs. As a result of the comparison at step S413, the CRL judged as newer is stored in the certificate revocation list storing unit CRL (S414) and the CRL is read out from the certificate revocation list storing unit CRL (S415). Further, the revocation list verification unit Che_CRL judges whether or not the certificate read-out at step S401 is registered in the CRL read-out at step S415 (S416). The process moves on to step S421 when the judgement at step S416 shows that the certificate is registered (S417). When it is not registered, the process moves on to the next step (S418).

The signature verification unit Ver_Sig verifies a validity of the signature read-out at step S401 using a certificate and a CRL read-out similarly at step S401 and a media key calculated at step S403 (S418). The process moves on to step S421 when the verification of the validity at step S418 indicates NG (S419). The process moves on to OK when the verification indicates OK (S420).

When the results of verifications and the like show OK or Play, the switch SW closes contact points. Then the content is stored into the content storing unit C and played back (S420).

When the results of verifications and the like show NG or No-Play, the switch opens the contact points and the content is not played back (S421).

Thus, an encrypted content and various data for decrypting the encrypted content are recorded on a DVD-RAM4. Since the content reading out decryption unit 242 has to decrypt the encrypted data using the various data, copy rights are sufficiently protected.

In the above mentioned embodiment, the CPRM, the CPS2 and the non-CP are used. However, any two of the methods can be used together or one of the methods only can be used. While the CPRM and the CPS2 are used for the CP method, other CP methods can be used.

Additionally, while music is used as contents to explain the present embodiment, the contents can be data such as video data, moving data and the like which take a similar format as music data.

Moreover, by recording a reference to HKB (revocation information) and a version for each content on the master music list, the CPS2 contents can be dealt with even when music data are added to the list.

As above described, data (music) corresponding to the CPRM, the CPS2, and the non-CP are recorded on the DVD-RAM4, being reflected on the master music list 130. For example, when such DVD-RAM4 is loaded on a reproducing apparatus 20 which corresponds only to the CPRM, the master music list reading out unit 241 reads the master music list and displays all music at a display unit 22. In here, when a user selects a piece of music corresponding to the CPS2 out of a large amount of music, the piece of music is not played back since it cannot be decrypted.

Under such situation, it is preferable to previously display music by distinguishing them respectively according to a CP method of a piece of music and whether or not the reproducing apparatus 20 can play back the piece of music.

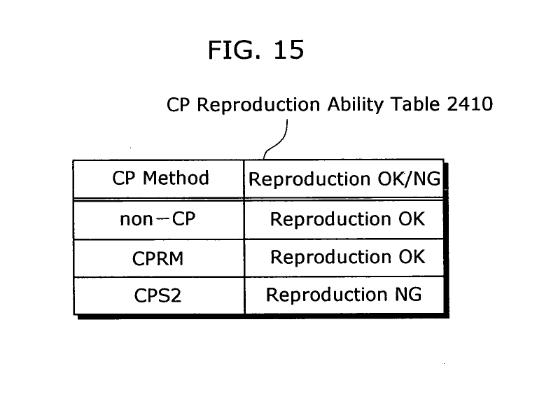

In response to this request, the master music list reading out unit 241 of the reproduction processing unit 24 in the reproducing apparatus 20 can display music recorded by the CPRM based on a master music list read-out from the DVD-RAM4, music recorded by the CPS2, and music recorded by the non-CP in a distinguishable format. Also, by previously having a CP generation ability table 2410 (refer to FIG. 15) which indicates a recording availability for each recording method in the content reading out decryption unit 242, it can display music available and music unavailable for reproduction in a distinguishable format at the CP generation ability table 2410 and the master music list 130 read-out from the DVD-RAM4.

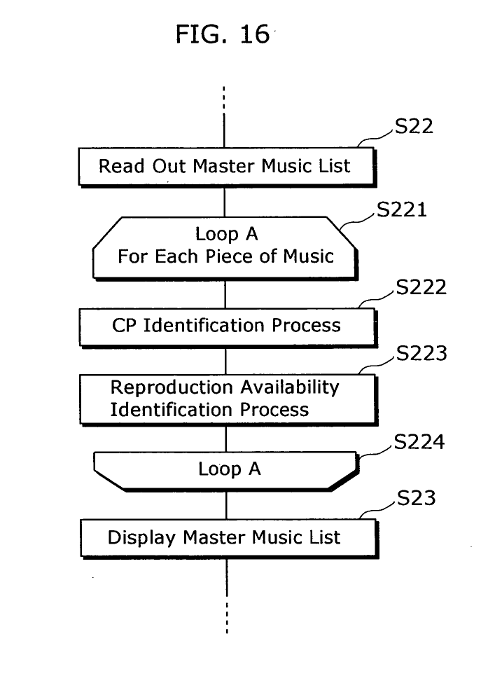

In a graphic example of FIG. 15, the CP generation ability table 2410 indicates respectively that music recorded by the non-CP and music recorded by the CPRM are available for reproduction and that music recorded by the CPS2 are unavailable for reproduction. In this case, the master music list reading out unit 241, as shown in FIG. 16, reads out a master music list written in the DVD-RAM 4 via the reading out unit 21 (S22), repeats the following process by each music included in the master music list, and determines a CP identification process and a reproduction availability process by each music (S221).

First, the master music list reading out unit 241 reads out a CP method 135 for a master music list read-out at step S22 and executes the CP identification process for displaying music recorded by the CPRM, music recorded by the CPS2, and music recorded by the non-CP in a distinguishable form (S222). Specifically, for example, a field corresponding to the CP method 135 is set up in data for display for the master music list and the CP method is stored in the field. After finishing the CP identification process, the master music list reading out unit 241 executes a reproduction availability identification process for displaying music available and music unavailable for reproduction in a distinguishable form by comparing the CP method of the music with the CP generation ability table 2410 (S223). Specifically, for example, a field for indicating reproduction availabilities (reproduction OK/NG) in display data for the master music list is set up. An icon datum which indicates reproduction OK is stored in the field when the CP method of the music is either the CPRM or the non-CP, and an icon datum which indicates reproduction NG is stored in the field when the CP method of the music is the CPS2.

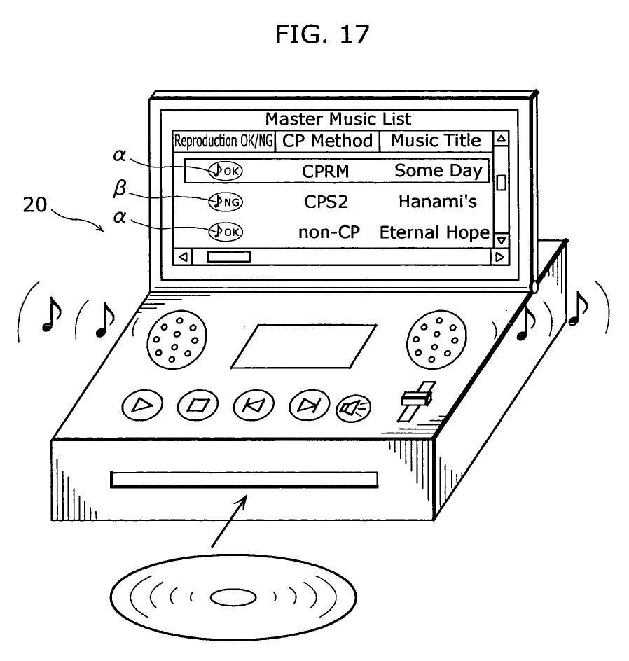

After executing the reproduction availability identification process, the master music list reading out unit 241 repeats the above mentioned process for the next music (S221˜S224). Then, after executing the CP identification process and the reproduction availability identification process for all music (S224), the master music list reading out unit 241, as shown in FIG. 17, displays a list of master music including data which indicates a CP method and an icon which indicates either reproduction OK or NG at the display unit 22 (S23). In here, an icon α shown in FIG. 17 indicates reproduction OK and an icon β indicates reproduction NG respectively.

Accordingly, a user can see all music written on a disk using a reproducing apparatus which only corresponds to a single CP (in here, CPRM) by having a function of reading out a master music list. In addition, since the master list clearly indicates a CP method and an availability of reproduction for each music, a user can see CP method and reproduction availability for each music. It also prevents a user from selecting “hanami's” by mistake.

In here, music for reproduction OK is indicated by icon a and music for reproduction NG are indicated by icon α. However, it can be indicated as music which is reproduction OK (CPRM/non-CP) by solid line and music which are reproduction NG (CPS2) by broken line. Also, it can be displayed by letters as well as displaying only music for reproduction OK (music for reproduction NG is not displayed).

The CP method can be also displayed by various methods other than letters such as icons and colors. For example, while a reproducing apparatus only corresponding to the CPRM is used in here as an example, the same thing applies to the case where the reproducing apparatus only corresponds to the CPS2.

Further, in the above mentioned structure of the content recording reproduction system 1 by the CPS2, two techniques such as a copy rights protection technique by key block revocation data and a copy rights protection technique by a signature and a CRL are used. However, it is not necessary to prevent the recorded data by an authorized recording apparatus from being reproduced on a reproducing apparatus. Therefore, only the copy rights protection technique by the key block revocation data should be sufficient enough.

Responding to this, the content recording reproduction system can be structured as follows.

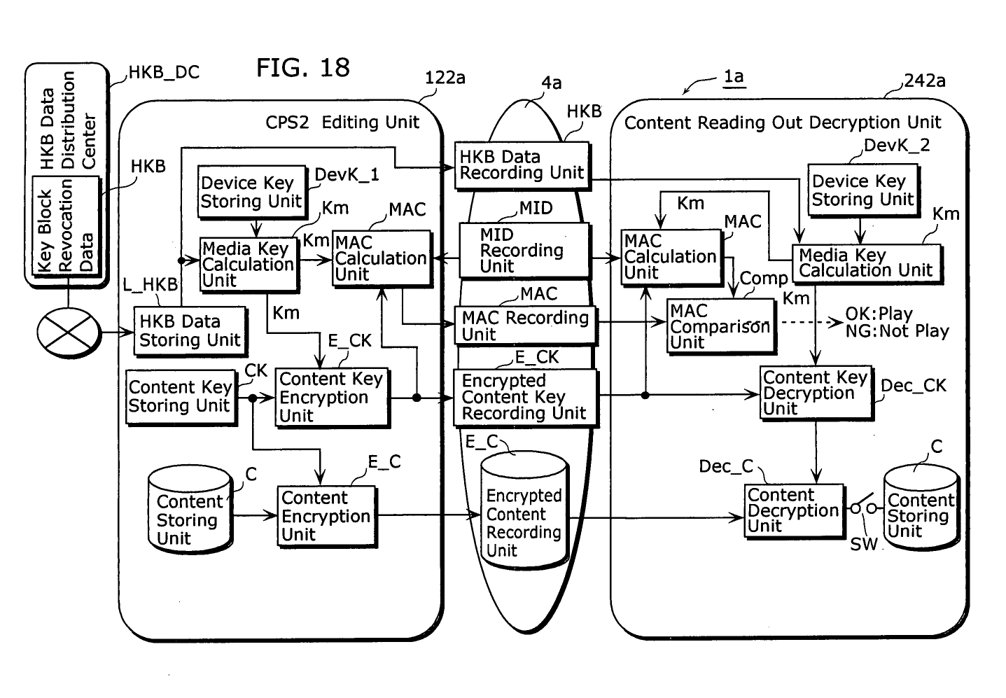

FIG. 18 is a conceptual diagram showing other overall structures of the CPS2 recording method used for the content recording reproduction system 1a. In here, a functional structure of the CPS2 editing unit 122a as a recording apparatus 10, a functional structure of the content reading out decryption unit 242 as a reproducing apparatus 20, and a recording structure by the CPS2 as a DVD-RAM4a are respectively indicated.

The CPS2 editing unit 122a is formed of a device key storing unit DevK_1, a key block revocation data storing unit L_HKB, a media key calculation unit Km, a message authentication code calculation unit MAC, a content key storing unit CK, a content key encryption unit E_CK, a content storing unit C, a content encryption unit E_C and the like.

Corresponding to the CPS2 editing unit 122a, the DVD-RAM4a includes a media ID recording unit MID, a key block revocation data recording unit HKB, a message authentication code recording unit MAC, an encrypted content key recording unit E_CK, and an encrypted content recording unit E_C.

The content reading out decryption unit 242a is formed of a device key storing unit DevK_2, a media key calculation unit Km, a message authentication code calculation unit MAC, a message authentication code comparison unit Comp, a content key decryption unit Dec_CK, a content decryption unit Dec_C, a switch SW, a content storing unit C, and the like.

That is, the CPS2 editing unit 122a has a simple structure which removed the secret key storing unit SecK_1, a signature generation unit Sig_G, a public key certificate storing unit Cert_1, and the certificate revocation list storing unit L_CRL from the CPS2 editing unit 122 shown in FIG. 10. Also, the content reading out decryption unit 242a has a simple structure which removed a certificate revocation list storing unit CRL, a CA public key storing unit PubK_CA, a certificate verification unit Ver_Cert, a revocation list verification unit Che_CRL, and a signature verification unit Ver_Sig from the content reading out decryption unit 242 as shown in FIG. 10.

Accordingly, in the content recording reproduction system 1a, a copy rights protection is provided by the copy rights protection technique using the key block revocation data. Also, by not using the copy rights protection technique using a signature and a CRL, the content recording reproduction system 1a is constructed at law cost, and the data memory space can be added to the DVD-RAM4a.

### INDUSTRIAL APPLICABILITY

The present invention applies to 1) recording media such as DVD-RAM on which one or more contents and a first list information indicating a list of said one or more contents are recorded by a first recording method, one or more contents and a second list information indicating a list of said one or more contents are recorded by a second recording method, and a common list information indicating a list of contents including contents indicated in the first list information and the contents indicated in the second list information are recorded, 2) a recording apparatus which records those contents onto a recording medium, and 3) a reproducing apparatus reproduces those contents by reading out them from the recording medium.

1. A recording medium on which contents are recorded, the contents being digital copyrighted works,
wherein on the recording medium, one or more first contents and first list information indicating a list of said one or more contents are recorded by a first recording method;
one or more second contents and second list information indicating a list of said one or more second contents are recorded by a second recording method; and
common list information indicating a list of contents including the contents indicated in the first list information and the contents indicated in the second list information are recorded.

2. The recording medium according to claim 1,
wherein the first recording method records contents after encrypting the contents to protect copyrights of the contents, and
the second recording method records contents without encrypting the contents.

3. The recording medium according to claim 1,
wherein the first recording method and the second recording method record contents after encrypting the contents to protect copyrights of the contents, and
the first recording method and the second recording method differ in methods for the encryption.

4. The recording medium according to claim 3,
wherein the first recording method records, onto the recording medium, the encrypted contents associated with secret information stored in a non-rewritable area of the recording medium, and the second recording method records, onto the recording medium, the encrypted contents associated with secret information stored in a non-rewritable area of the recording medium, and
types of the secret information are different for the first recording method and the second recording method, the secret information being stored in the non-rewritable area of the recording medium.

5. The recording medium according to claim 4,
wherein by the first recording method, key revocation data and identification information are stored in the non-rewritable area of the recording medium as the secret information, the key revocation data being used to revoke a secret key held by an apparatus which reproduces the recording medium and the identification information being used to identify the recording medium, and
by the second recording method, only the identification information for identifying the recording medium is stored in the non-rewritable area of the recording medium as the secret information.

6. The recording medium according to claim 1,
wherein the common list information further includes information for specifying the recording methods for the contents.

7. The recording medium according to claim 6,
wherein the first list information and the second list information further include other information relating to said one or more contents respectively, and
the common list information includes all the information included respectively in the first list information and the second list information.

8. The recording medium according to claim 1,
wherein at least one of the first recording method and the second recording method uses key revocation data for revoking a secret key held by an apparatus which reproduces the recording medium, and
the common list information includes information for specifying the key revocation data.

9. The recording medium according to claim 8,
wherein at least one of the first recording method and the second recording method further uses a revocation list which is a list of information indicating a public key certificate to be revoked held by an apparatus which reproduces the recording medium, and
the common list information further includes information for specifying a website on the Internet on which the revocation list is stored.

10. The recording medium according to claim 1 which is a rewritable DVD.

11. The recording medium according to claim 1,
wherein the contents are music data, and the first list information, the second list information and the common list information are music lists.

12. A recording apparatus which records contents that are digital copyrighted works onto a recording medium, comprising:
a first recording unit operable to record one or more first contents and first list information indicating a list of said one or more first contents onto the recording medium by a first recording method;
a second recording unit operable to record one or more second contents and second list information indicating a list of said one or more second contents onto the recording medium by a second recording method; and
a third recording unit operable to generate common list information indicating a list of contents including the first contents indicated in the first list information and the second contents indicated in the second list information, and record the common list information onto the recording medium.

13. The recording apparatus according to claim 12,
wherein the third recording unit generates the common list information including information for specifying the recording methods for the contents.

14. The recording apparatus according to claim 12,
wherein the third recording unit generates the common list information including information for specifying key revocation data for revoking a secret key held by an apparatus which reproduces the recording medium.

15. The recording apparatus according to claim 14,
wherein the third recording unit generates the common list further including information for specifying a website on the Internet on which a revocation list is stored, the revocation list being a list of information indicating a public key certificate to be revoked held by an apparatus which reproduces the recording medium.

16. A reproducing apparatus which reads out a content from a recording medium on which contents that are digital copyrighted works are recorded and reproduces the content,
wherein on the recording medium, one or more first contents and first list information indicating a list of said one or more contents are recorded by a first recording method;
one or more second contents and second list information indicating a list of said one or more second contents are recorded by a second recording method; and
common list information indicating a list of contents including the contents indicated in the first list information and the contents indicated in the second list information are recorded, and
the reproducing apparatus comprises:
a reading out unit operable to read out the common list information recorded on the recording medium;
a display unit operable to display the list of contents indicated in the read-out common list information;
an instruction obtaining unit operable to obtain a selection instruction by a user for making a selection from the displayed list of the contents; and
a reproducing unit operable to read out a content corresponding to the obtained selection instruction and reproduce the content.

17. The reproducing apparatus according to claim 16,
wherein the common list information further includes information for specifying a recording method for the content, and
the reproducing unit specifies the recording method for the content corresponding to the selection instruction with reference to the common list information, reads out the content from the recording medium by a method corresponding to the specified recording method, and reproduces the content.

18. The reproducing apparatus according to claim 16,
wherein at least one of the first recording method and the second recording method uses key revocation data for revoking a secret key held by an apparatus which reproduces the recording medium,
the common list information further includes information for specifying the key revocation data, and
the reproducing unit refers to key revocation data indicated by said information included in the common list information.

19. The reproducing apparatus according to claim 18,
wherein at least one of the first recording method and the second recording method further uses a revocation list, the revocation list being a list of information indicating a public key certificate to be revoked held in an apparatus which reproduces the recording medium,
the common list information further includes information for specifying a website on the Internet on which the revocation list is stored, and
the reproducing unit further includes a revocation list obtaining unit operable to obtain the revocation list from the website via the Internet based on the information for specifying the website.

20. The reproducing apparatus according to claim 16,
wherein the common list information further includes information for specifying a recording method for the content,
the reading out unit previously holds reproduction availability information indicating an availability of a content reproduction for each method in the reproducing unit, and executes a reproduction availability identification process for identifying whether or not the content is allowed to be reproduced by comparing the common list information with the reproduction availability information, and
the display unit displays whether or not the content is allowed to be reproduced in a distinguishable manner according to the reproduction availability identification process.

21. A content recording reproduction system comprising a recording medium, the recording apparatus and the reproducing apparatus,
wherein the recording apparatus comprises a first recording unit operable to record one or more first contents and first list information indicating a list of said one or more first contents onto the recording medium by a first recording method;
a second recording unit operable to record one or more second contents and second list information indicating a list of said one or more second contents onto the recording medium by a second recording method; and
a third recording unit operable to generate common list information indicating a list of contents including the first contents indicated in the first list information and the second contents indicated in the second list information, and record the common list information onto the recording medium, and
the reproducing apparatus comprises:
a reading out unit operable to read out the common list information recorded on the recording medium;
a display unit operable to display the list of contents indicated in the read-out common list information;
an instruction obtaining unit operable to obtain a selection instruction by a user for making a selection from the displayed list of the contents; and
a reproducing unit operable to read out a content corresponding to the obtained selection instruction and reproduce the content.

22. A recording method for recording contents that are digital copyrighted works onto a recording medium, including:
a first recording step of recording one or more contents and first list information indicating a list of said one or more contents onto the recording medium by a first recording method;
a second recording step of recording one or more contents and second list information indicating a list of said one or more contents onto the recording medium by a second recording method; and
a third recording step of generating common list information indicating a list of contents including the contents indicated in the first list information and the contents indicated in the second list information.

23. A reproduction method by which a content is read out from a recording medium on which contents that are digital copyrighted works are recorded and reproduced,
wherein on the recording medium, one or more first contents and first list information indicating a list of said one or more contents are recorded by a first recording method;
one or more second contents and second list information indicating a list of said one or more second contents are recorded by a second recording method; and
common list information indicating a list of contents including the contents indicated in the first list information and the contents indicated in the second list information are recorded, and
the reproduction method includes:
a reading out step of reading out the common list information recorded on the recording medium;
a displaying step of displaying the list of contents indicated in the read-out common list information;
an instruction obtaining step of obtaining a selection instruction by a user for making a selection from the displayed list of the contents; and
a reproducing step of reading out a content corresponding to the obtained selection instruction from the recording medium and reproducing the content.

24. A program for a recording apparatus to record contents that are digital copyrighted works onto a recording medium, and the program causing a computer to function as units of a recording apparatus, the recording apparatus comprising:
a first recording unit operable to record one or more first contents and first list information indicating a list of said one or more first contents onto the recording medium by a first recording method;
a second recording unit operable to record one or more second contents and second list information indicating a list of said one or more second contents onto the recording medium by a second recording method; and
a third recording unit operable to generate common list information indicating a list of contents including the first contents indicated in the first list information and the second contents indicated in the second list information, and record the common list information onto the recording medium.

25. A program for a reproducing apparatus which reads out a content from a recording medium on which contents that are digital copyrighted works are recorded and reproduces the content,
wherein on the recording medium, one or more first contents and first list information indicating a list of said one or more contents are recorded by a first recording method;
one or more second contents and second list information indicating a list of said one or more second contents are recorded by a second recording method; and
common list information indicating a list of contents including the contents indicated in the first list information and the contents indicated in the second list information are recorded, and
the program causing a computer to function as units of the reproducing apparatus,
wherein the reproducing apparatus comprises:
a reading out unit operable to read out the common list information recorded on the recording medium;
a display unit operable to display the list of contents indicated in the read-out common list information;
an instruction obtaining unit operable to obtain a selection instruction by a user for making a selection from the displayed list of the contents; and
a reproducing unit operable to read out a content corresponding to the obtained selection instruction and reproduce the content.
